(19) United States
(12) Patent Application Publication
(10) Pub. No.: US 2023/0338222 A1
(43) Pub. Date: Oct. 26, 2023

(54) SELF-BALANCING HARNESS FOR WEARABLE ASSISTANCE DEVICES

(71) Applicant: Vanderbilt University, Nashville, TN (US)

(72) Inventors: Paul Slaughter, Nashville, TN (US); Katherine Rodzak, Nashville, TN (US); Derek Wolf, Nashville, TN (US); Karl E. Zelik, Nashville, TN (US)

(21) Appl. No.: 18/306,466

(22) Filed: Apr. 25, 2023

Related U.S. Application Data
(60) Provisional application No. 63/334,565, filed on Apr. 25, 2022.

(51) Int. Cl. A61H 3/00; B25J 9/00

(52) U.S. Cl. CPC A61H 3/008; B25J 9/0006; F41H 1/00

(57) ABSTRACT

A harness for a wearable assistance device that has an inner support configured to be attached to a first side of a body interface and a movable outer support slidably coupled to the inner support and configured to connect to a wearable assistance device. A strap attachment is connected to the movable outer support and is configured to be attached to a second side of the body interface that is opposite the first side of the body interface. The movable outer support moves axially relative to the inner support from an unloaded position to a loaded position upon application of a load from the wearable assistance device.

### CROSS-REFERENCE TO RELATED APPLICATIONS

This application claims the benefit of priority of U.S. Application Ser. No. 63/334,565 filed on Apr. 25, 2022, and entitled “Self-Balancing Harness for Exosuit”, the content of which is relied upon and incorporated herein by reference in its entirety.

### GOVERNMENT SPONSORSHIP

This invention was made with government support under grant W911NF2120078 awarded by the U.S. Army. The government has certain rights in the invention.

### FIELD OF THE INVENTION

Embodiments are in the field of wearable assistance devices such as exosuits/exoskeletons. More particularly, embodiments disclosed herein relate to wearable assistance devices for reducing muscle stress, fatigue, injury and pain in the lower back or other body segments.

### BACKGROUND

Historically, wearable assistance devices have been standalone devices (i.e., separate, add-on accessories) with their own body interfaces (e.g., vests, sleeves), and have not been designed to integrate or attach directly onto existing worn equipment or gear (e.g., body armor, backpacks). That is because it is important to apply assistive forces to the user's body in a way that does not result in unwanted consequences, such as shifting of the device interface on the user's body which can cause discomfort or chaffing. In addition, integrating wearable assistance devices directly onto other equipment or gear (e.g., body armor, safety harnesses) is difficult.

Backpacks are a different type of wearable gear that also have to attach to the body in way that does not result in discomfort or other undesired consequences. For instance, certain backpack innovations have been developed to minimize the bouncing action of the bag load during movement to improve comfort and weight distribution. One such backpack is disclosed in U.S. Patent Application Publication No. 2012/0048904 (“the '904 publication). The '904 publication teaches a backpack that has self-adjusting straps that can extend or contract in response to the weight of the backpack and to the size or shape of the user, to improve weight distribution of the backpack load on the user's shoulders and to minimize the bouncing action of the backpack during movement. The self-adjusting straps of the '904 publication are coupled to the back panel only of the backpack and only at the bottom of the panel such that the top portion of the straps, which must be free to engage a user's shoulders, are free from a fixed attachment to the back panel. The straps of the backpack are configured to automatically adjust based on the weight of the cargo placed within the backpack, as well as the size of the user. However, the backpack disclosed in the '904 patent publication achieves self-adjustment by attaching the straps of the backpack only to the bottom of the back panel of the backpack, which is designed to be useful for backpack loads, but is not designed to be useful, usable or suitable for wearable assistance devices that apply different types and directions of forces.

Thus, it is desirable to provide a harness and method of using a harness that are able to overcome the above-described limitations and disadvantages for wearable assistance devices. Advantages of the present disclosure will become more fully apparent from the detailed description hereinbelow.

### SUMMARY

Accordingly, the present disclosure may provide a harness for a wearable assistance device that comprises an inner support configured to be attached to a first side of a body interface and a movable outer support slidably coupled to the inner support and configured to connect to a wearable assistance device. A strap attachment is connected to the movable outer support and configured to be attached to a second side of the body interface that is opposite the first side of the body interface. The movable outer support moves axially relative to the inner support from an unloaded position to a loaded position upon application of a load from the wearable assistance device.

In certain embodiments, a movable connecting mechanism is positioned at the inner support, at the outer support, or between the inner support and outer support, and the movable connecting mechanism is configured to allow the outer support to be slidably coupled to the inner support; the movable connecting mechanism comprises at least one fastener receivable in at least one corresponding slot; a length of the at least one corresponding slot defines the maximum displacement of the outer support with respect to the inner support; one or more elastic elements couple the outer support to the inner support, wherein the elastic element is configured to deform when the outer support moves relative to the inner support; and/or the one or more elastic elements are elastic bands.

In other embodiments, a top portion of the inner support is configured to connect to the first side of a body interface, and a bottom portion of the outer support is configured to connect to the second side of the body interface via the strap attachment; the first side of the body interface is at a user's posterior trunk, and the second side of the body interface is at a user's anterior trunk; the strap attachment includes at least one strap connected at one end to the outer support and at an opposite end to the second side of the body interface; each of the inner and outer supports is a plate; the outer support is connected to at least one element of the wearable assistance device that provides assistive force.

The present disclosure may also provide a harness for a wearable assistance device that comprises an inner plate configured to be attached to a first side of a body interface wearable by a user and a movable outer plate slidably coupled to the inner plate and configured to connect to at least one element of a wearable assistance device that provides assistive force. A strap attachment is connected to the movable outer plate and configured to be attached to a second side of the body interface that is opposite the first side of the body interface. The movable outer plate moves axially relative to the inner plate from an unloaded position to a loaded position upon application of a load from the wearable assistance device to balance against the assistive force.

In some embodiments, the strap attachment includes at least one strap connected at one end to the outer plate and at an opposite end to the second side of the body interface; a bottom portion of the outer plate is connected to the one end of the at least one strap of the strap attachment; the at least one strap runs under the arm of the user; and/or a movable connecting mechanism is positioned at the inner plate, at the outer plate, or between the inner plate and outer plate, the movable connecting mechanism is configured to allow the outer plate to be slidably coupled to the inner plate and defines the maximum displacement of the outer plate with respect to the inner plate.

In other embodiments, the movable connecting mechanism comprises at least one fastener receivable in at least one slot; one or more elastic elements couple the outer and inner plates at a bottom portion of the outer and inner places, wherein the elastic element is configured to deform when the outer plate moves relative to the inner plate; and/or the body interface is a body armor vest, backpack, fall protection, or other vest or body-worn gear.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIGS. 1A and 1B are images of a harness according to an exemplary embodiment of the present disclosure, showing the harness incorporated into a body interface and used with a wearable assistance device that uses elastic bands to assist a user's back during bending and lifting;

FIG. 2 is an image of an inner support of the harness illustrated in FIG. 1A;

FIG. 3 is an image of an outer support of the harness illustrated in FIG. 1A;

FIG. 4 is an image of the inner and outer supports of the harness of FIGS. 2 and 3 connected by elastic elements;

FIG. 5 is an enlarged image of the harness illustrated in FIG. 1A, showing the direction of the outer support sliding when the harness is loaded; and

FIGS. 6A and 6B are enlarged partial images of the harness illustrated in FIG. 1A, showing the unloaded and loaded positions, respectively, of the harness illustrated in FIG. 5.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical wearable assistance device or typical method of using a wearable assistance device. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

It should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting. It should further be understood that any one of the described features may be used separately or in combination with other features. Other invented devices, systems, methods, features, and advantages will be or become apparent to one with skill in the art upon examining the drawings and the detailed description herein. It is intended that all such additional devices, systems, methods, features, and advantages be protected by the accompanying claims.

For purposes of this disclosure, the phrase “body segment” may include a body part such as a back, lumbar spine, hip, neck, etc., or a body joint such as an ankle, knee, elbow, wrist, etc., and thus, may all be used interchangeably. Also, the phrase “body segment” may include multiple body parts or body joints.

For purposes of this disclosure, the phrase “wearable assistance device” may be an exosuit, exoskeleton, prosthesis, orthosis, or other device that provides physical assistance, resistance, support or mechanical advantage about a body segment of a user, and may be passive, quasi-passive, or powered.

For purposes of this disclosure, the term “harness” may be any member that connects between a body interface (e.g., vest, sleeve, cuff, shirt, jacket, coat, or pants) and other members of a wearable assistance device (e.g., a clutch, elastic bands, motor). The body interface connects to a user's body segment.

For purposes of this disclosure, the phrases “elastic band”, “elastic element”, and “elastic member” may be used interchangeably, and may be any member that has an amount of elasticity associated with it and which can take the form of, for example, a spring, cable, string, strap, cord, webbing, rope, band, beam, gas-spring, pneumatic, carbon fiber, fiber glass, etc., and may be coiled or non-coiled. The elastic element may have a linear or non-linear stiffness profile.

For purposes of this disclosure, the phrase “body interface” refers to body interfaces that can be positioned anywhere on the user's body, including an upper body interface placed higher relative to a lower body interface, assuming the user is in a standing/vertical position. The term “body interface” or “interface” refers to the component or components of a wearable assistance device that physically connect or attach to a body segment of a user. An interface may include, for instance, a vest, sleeve, cuff, shirt, jacket, coat, or pants.

The present disclosure relates to a harness designed to be load-balancing/self-balancing and that can be used with a wearable assistance device, such as exoskeletons or exosuits, including when integrating the assistance device into or onto a body interface, such as body equipment, body gear, clothing, body armor, backpacks, fall protection harnesses, and the like. The harness can be a component of the assistive device, used to connect between one or more assistive elements of the assistive device and the user's body interface. The harness is designed to tighten when under load (i.e., when the assistive device is providing assistance or an assist force in a way that balances forces on the anterior and posterior parts of the body interface such that the harness reduces shifting of the wearable assistance device relative to the body in unwanted ways (e.g. up against the user's throat). The harness is designed to then loosen when it is not under load (i.e., when the wearable assistance device is not providing assistance). Thus, the harness is configured such that the tightening occurs only when the harness is under load. That is beneficial because when the harness tightens, the harness balances biomechanical load paths in a way that reduces shifting that occurs between the assistive device and the user, which otherwise could be a source of discomfort, like chaffing or pressure against the user's throat. Secondly, by allowing the harness to be looser when not under load, the harness can be more physically and thermally comfortable.

Referring to the figures, the self-balancing harness 100 of the present disclosure generally includes an inner support 110 that is positioned at one side of a body segment (e.g., posterior trunk) and a movable outer support 120 that couples to the inner support 110 and is connectable to the other opposite side of the body segment (e.g., anterior trunk) via a strap attachment 130. A movable connecting mechanism 140 is associated with the inner and outer supports 110 and 120 and allows the outer support 120 to slide relative to the inner support 110 (e.g., along the longitudinal axis of the body segment). One or more elastic elements 150 (e.g., elastic bands, springs or the like) can connect the inner support 110 and the outer support 120. The harness 100 facilitates the application of assistive forces by a wearable assistance device 20 to a body interface 10, such as existing worn equipment or gear, while retaining device function and comfort.

The harness 100 of the present disclosure is designed to be attached to existing equipment, such as a body armor vest 10, without a complete loop of a shoulder strap (as in the backpack), which provides functional benefits in terms of usability, fit, and form-factor. Additionally, the harness 100 uses two sliding supports 110 and 120 to achieve the motion instead of connecting a strap to a single point with elastic. The harness 100 prevents shifting of the wearable assistance device 20 about the user's body when the wearable assistive force is being provided (e.g., to prevent chaffing or choking effects).

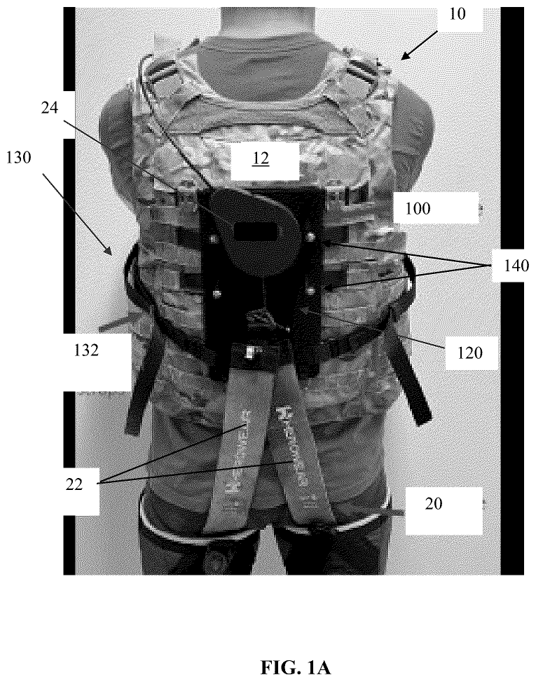

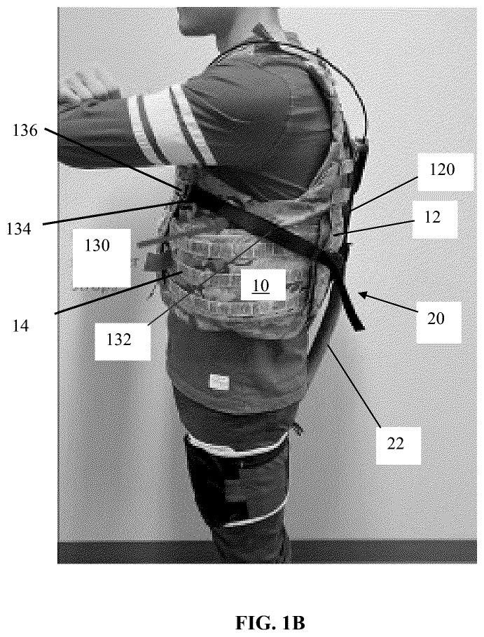

FIGS. 1A and 1B are images of the self-balancing harness 100 according to an exemplary embodiment of the present disclosure, showing the harness 100 incorporated into a body interface 10 and used with a wearable assistance device 20, such as an exosuit. In the example shown in FIGS. 1A and 1B, the harness 100 is integrated with body armor 10, such as a U.S. Army-issued Improved Outer Tactical Vest (IOTV).

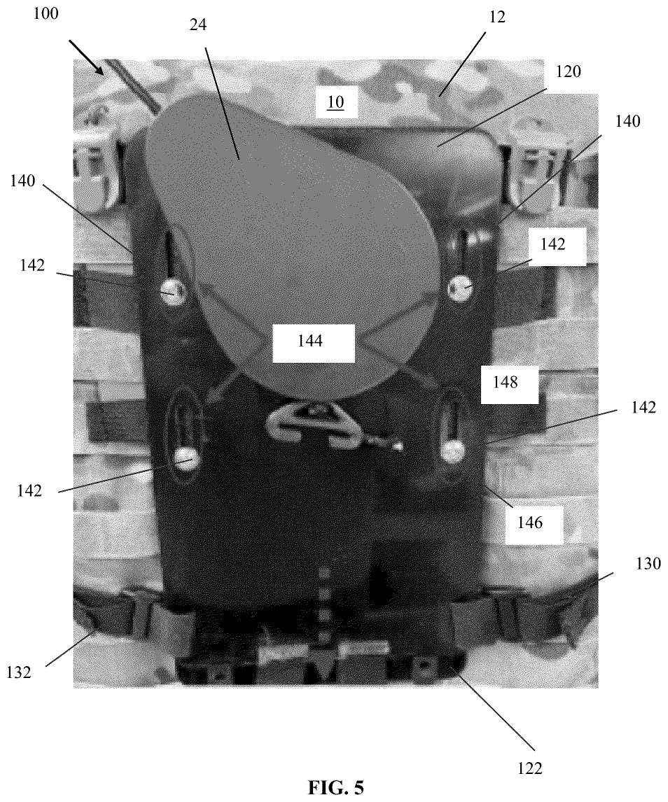

As seen in FIGS. 1A and 1B, the harness 100 comprises the inner support 110, which is configured to be attached to a first side 12 of a body interface 10, such as the back of a body armor vest; the outer support 120 is slidably coupled to the inner support 110 and is configured to connect to a wearable assistance device 20. The strap attachment 130 may be used to connect the movable outer support 120 to a second side 14 of the body interface 10 that is opposite the first side 12 of the body interface 10, such as the front side of the body armor vest. The movable outer support 120 is configured to move axially in a longitudinal direction (FIG. 5) relative to the inner support 110 from an unloaded position to a loaded position upon application of a load from the wearable assistance device 20. In an example, the harness's inner support 110 attaches to the back of an IOTV and the harness's outer support 120 attaches to the front of the IOTV via the strap attachment 130 which can be an under-shoulder strap attachment. The other components of the exosuit can be mounted to the outer support 120 of the harness 100.

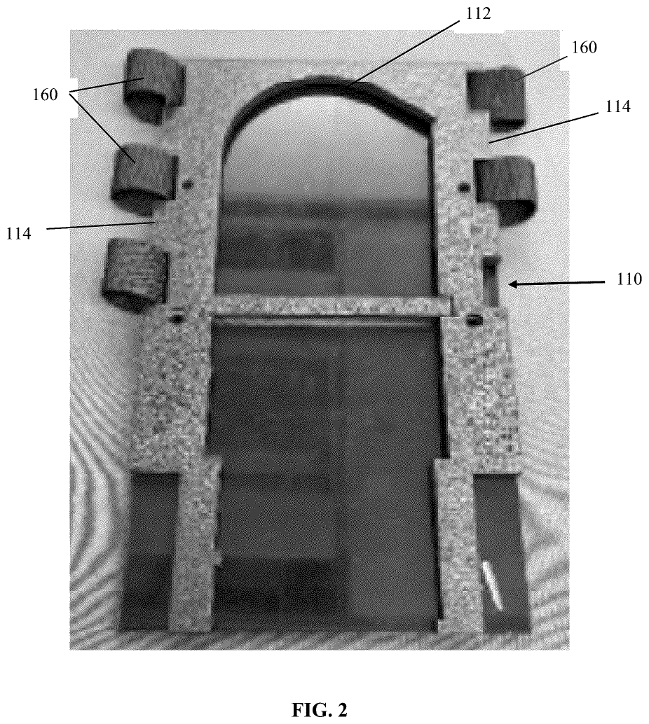

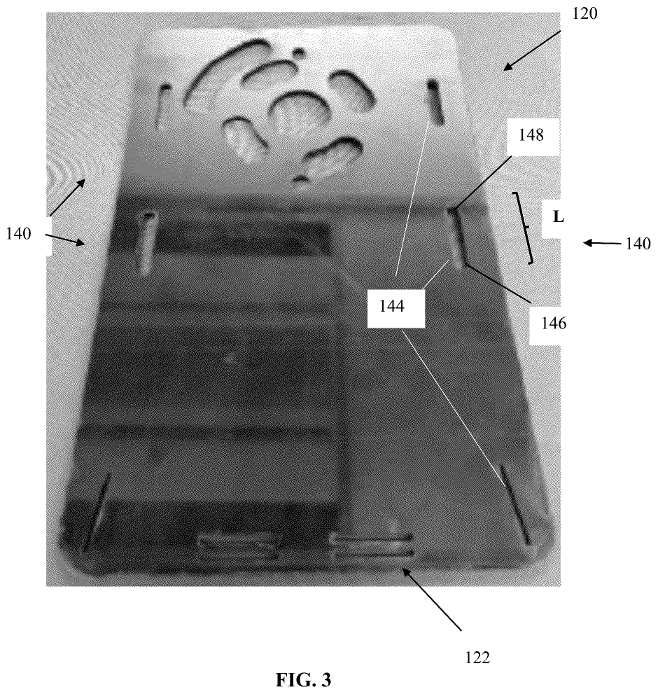

As seen in FIGS. 2 and 3, in one example of the present disclosure, the inner and outer supports 110 and 120 may be plates. The plates may be formed of a rigid or substantially rigid material, such as metal, plastic, or a composite. The inner support 110 can be integrated directly into the back side 12 of the body interface 10 or attached to an outer surface of the back side 12 of the body interface 10.

The strap attachment 130 is designed to connect the harness 100 to the opposite side, e.g. the front side 14 (FIG. 1B), of the body interface 10. The strap attachment 130 runs between the front side 14 of the body interface 10 and the outer support 120. The strap attachment 130 may include one or more straps 132 which connect at one end to the outer support 120, such as at a bottom portion 122 of the outer support 120, and connect at an opposite end 134 to the front 14 of the body interface 10, as best seen in FIGS. 1A and 1B.

The one or more straps 132 can attach from the outer support 120 to the front side 14 of the body interface 10 by running under the shoulder (or under the armpit) of the user, as seen in FIGS. 1A and 1B. To achieve that attachment to the front side 14 of the body interface 10, each strap 132 that extends from the outer support 120 can have a coupler, such as a hook or the like, on its end 134, which can engage a corresponding element 136, such as a loop or the like, at the front side 14 of the body interface 10 into which the coupler at the strap's end 134 hooks into. It is noted that any type of coupling can be used to attach the ends of the straps 132 to the front side 14 of the interface 10. Straps 132 can also be adjustable.

As the outer support 120 slides longitudinally down with respect to the inner support 110, the under-shoulder straps 132 tighten (increase tension). That increased tension creates greater friction between the body interface 10 and the user's body and provides a counterbalancing force to the force exerted by the inner support 110 on the back side 12 of the body interface 10. In other words, when the outer support 120 slides, the outer support 120 creates a biomechanical load path that counterbalances the loading dynamics of the inner support 110. While the inner support 110 is pulling down on the back side 12 of the body interface 10, the straps 132 that connect the outer support 120 to the front side 14 of the body interface 10 become under more tension, pulling the front side 14 of the body interface 10 into the chest and down.

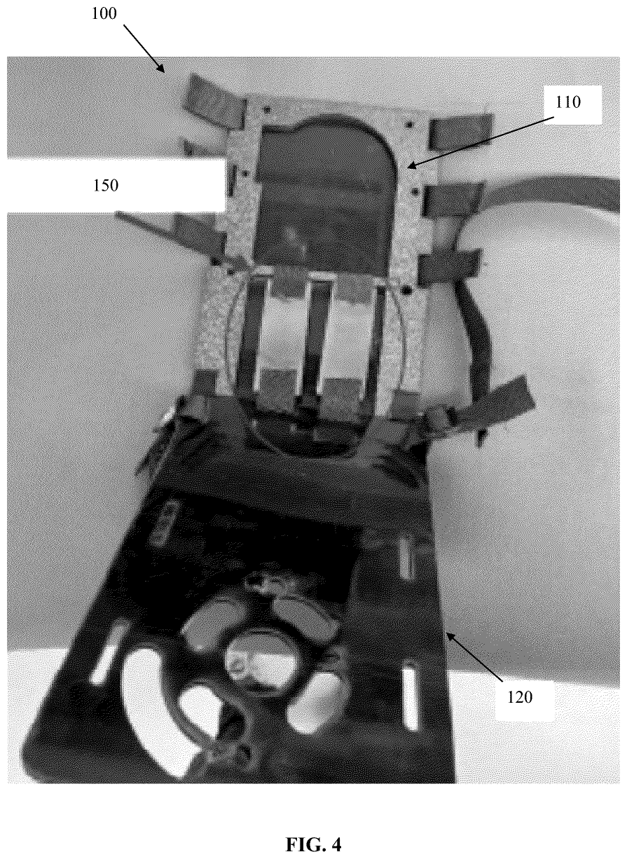

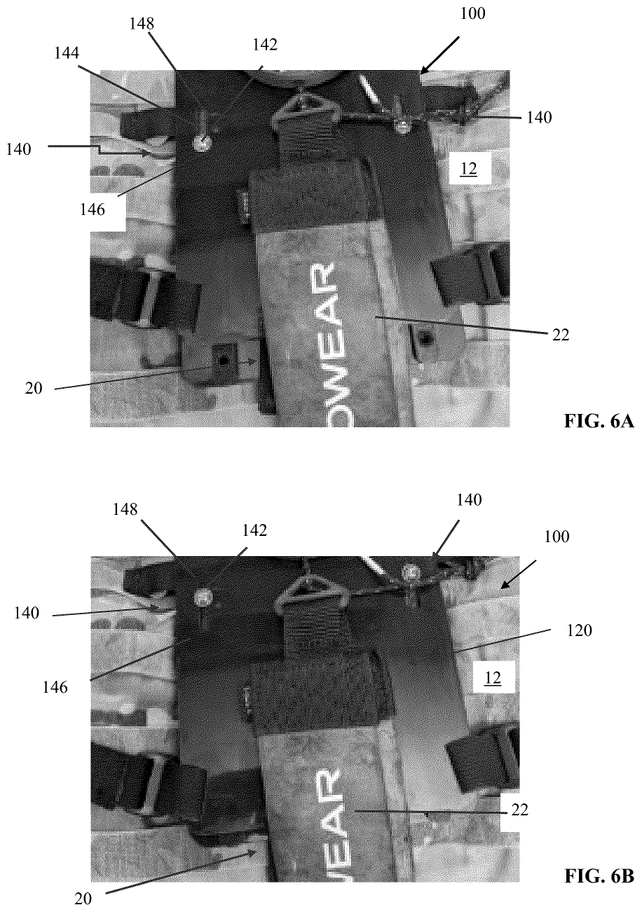

FIG. 4 illustrates the inner support 110 of the harness 100 coupled to the outer support 120 of the harness 100 via the one or more elastic elements 150 (such as elastic band or spring). The elastic elements 150 are capable of deforming when the outer support 120 moves relative to the inner support 110. The elastic elements 150 are designed to resist the sliding of the outer support 120 relative to the inner support 110 under load to a loaded position (e.g., due to force from an assistive element of the assistance device 20, as seen FIG. 6B) and ensures that the outer support 120 returns to its unloaded position (FIG. 6A) when the load is removed.

The one or more elastic elements 150 can be contained within the harness 100 and connect the inner support 110 and the outer support 120 (FIG. 4). When an assistive force is being provided by the wearable device 20, the outer support 110 is able to slide down, to a maximum displacement defined by the connectable mechanism 140. The elastic elements 150 act to resist sliding of the outer support 120 relative to the inner support 110.

Other components of the assistive device 20 can be mounted onto the self-balancing harness 100. For example, the other components may include assistive elastic bands 22, which are configured to apply an assistive force about the user's lower back when the user bends or lifts. Another component that can be mounted to the harness 100, and particularly to an outer surface of the outer support 120, is a clutch-switch mechanism 24. Another component that can be mounted to the harness 100, and particularly to an outer surface of the outer support 120, is a powered actuator, for instance, comprising an electric motor, or pneumatic or hydraulic actuator. Various alternative or additional components of the assistance device could also be affixed to the self-balancing harness 100.

In an embodiment, the inner support 110 (FIG. 2) is attached to the back side 12 of the body interface 10 via one or more couplers 160. The couplers 160 may be any known type, such as Molle loops, hook and loop material, ties, stitches, adhesive, fasteners, and the like. The couplers 160 may be provided anywhere on the inner support 110, such as at a top portion 112 or at either or both side edges 114 of the inner support 110, as seen in FIG. 2. As such, any portion of the inner support 110 can be attached to or integrated into the back side 12 of the body interface 10.

The movable connecting mechanism 140 of the harness 100 is designed to allow the outer plate 120 to slide axially with respect to the inner plate 110. The movable connecting mechanism 140 can be located at or on one or both of the inner support 110, the outer support 120, and/or between the inner and outer supports 110 and 120. In an example, the movable connecting mechanism 140 may comprise one or more fasteners 142 that are receivable in one or more corresponding slots or rails 144 (FIG. 3). The one or more fasteners 142 may be any type of known fastener, such as bolts, screws, rods and the like. In an embodiment, the one or more fasteners 142 can be mounted to the inner support 110 and extend through the one or more slots or rails 144 disposed on the outer support 120, as seen in FIG. 5. A length L (FIG. 3) of each slot or rail 144 defines the maximum displacement of the outer support 120 relative to the inner support 110 when the outer support 120 moves or shifts longitudinally from the unloaded position (FIG. 6A) to the loaded position (FIG. 6B). In an example, the maximum displacement can be about 1 inch.

FIG. 6A shows the outer support 120 in the unloaded position retracted up by the internal elastic elements 150 when not under load. In the unloaded position, each fastener 142 of the movable connecting mechanism 140 is positioned at the bottom 146 of the respective slot 144. FIG. 6B shows the outer support 120 in the loaded position with the assist element or elements 22 of the wearable assistance device 20 applying a downward force, such that the outer support 120 stretches the internal elastic elements 150 (FIG. 4) and shifts down along the inner support 110. In the loaded position, each fastener is at the top 148 of the respective slot 144. The distance between the bottom 146 and the top 148 of each slot 144 defines the maximum displacement of the outer support 120 with respect to the inner support 110.

The design of the self-balancing harness 100 of the present disclosure prevents the body interface from slipping up and choking the user. Without the increased tension in the under-shoulder straps 132, which occurs because the outer support 120 can slide downward relative to the inner support 110, the force pulling downward on the back side 12 of the body interface 10 would tend to cause the body interface 10 to shift backwards on the body (e.g., to the point where the front collar of the body interface would push upon the user's neck). That shifting of the body interface 10 (and attached harness) on the body would also detract from assistance from the assistive elements 22 of the assistance device 20. Thus, without that sliding function of the outer support 120 relative to the inner support 110, the entire body interface can shift posteriorly and choke the user and the assistive benefits of the assistance device 20 would be degraded. Therefore, the sliding behavior of the outer support 120 relative to the inner support 110 allows for ease of usability by the user, effectiveness of the harness 100, user comfort and for the assistance device to function properly, e.g., to provide its intended assistance to the user.

The design of the harness 100 of the present disclosure provides a way to eliminate the need for any shoulder straps of the device to travel all the way above the user's shoulders (in a loop like backpack straps). Instead, the harness 100 is connected to the back and sides of the body interface (without going over the shoulders), which allows the design to be more minimal. However, in other embodiments, the harness shoulder straps could be routed above the shoulders, such that the straps are connected to the bottom portion 122 of the outer support 120, route under the armpit, then above the shoulders, and then reconnect to the top portion 112 of the inner support 110 (in a loop similar to backpack straps). In that case, the self-balancing harness 100 would still apply counterbalancing forces that accomplish the function outlined above in terms of preventing unwanted shifting of the wearable assistance device on the user's body. In embodiments that loop over the shoulders, this assistance device could also be worn as a separate standalone device, for instance, useful for users who sometimes wear it with body armor and sometimes wear it without body armor.

The harness 100 design allows an exosuit or exoskeleton 20 to be connected to an existing piece of equipment or gear 10 (e.g. IOTV, safety harness, shirt, clothing) in a way that prevents the underlying equipment or gear from shifting backwards due to loads on/from the exosuit. In some embodiments that can be done without the harness including above-the-shoulder straps (e.g., it would instead employ the under-shoulder straps described herein), which can be beneficial in terms of reducing bulk or clutter on (above) the user's shoulders. The harness 100 has a sliding back support design which allows the straps 132 which run under the arms to the front attachment point to automatically tighten when the exosuit 10 is engaged and providing force. The tension in those straps 132 helps to provide a counterbalance to the downward exosuit force and minimizes the backwards shifting of the equipment or gear that is worn underneath it. Additionally, by allowing the harness 100 to be looser when not under load, the harness can be more physically and thermally comfortable.

There are various alternative embodiments to the harness and to what it connects. The body interface 10 can be any type of wearable gear or equipment, such as other kinds of vests, exoskeletons, backpacks, or clothing. The assistive elements mounted to the harness 100 (e.g., elastic bands 22 connected via a clutch 24) could be any type of assistive element, such as a passive elastic band, spring without a clutch, motor, or other kind of actuator. The assistive elements of the device 20 could also be positioned on other body segments (e.g., mounted to the thigh interface components) while still integrating with (connecting onto) the self-balancing harness described herein. The self-balancing harness 100 could be applied to other body segments beyond the trunk, such as the arms, legs, head, or pelvis.

There are other materials that could be used in place of the elastic elements 150 between the two supports 110 and 120, such as a tension spring, compression spring, bungee cord or other elastic material (including viscoelastic materials). The rails or slots 144 which constrain the sliding of the outer support 120 could be made using other mechanisms or materials, such as but not limited to spring loaded tubes, low-friction slots, or slide rails. Inner and outer supports 110 and 120 could connect to underlying gear/equipment/clothing worn by the user by using methods/devices other than Molle loops.

The self-balancing harness 100 may include additional features, such as a hard or soft stop that prevents the outer support 120 from sliding downward more than a prescribed distance. The elastic elements 150 between the supports 110 and 120 may consist of one or more elastic elements, and may be linear or non-linear springs, or may be preloaded or constant stiffness springs. In some embodiments, that elastic element between the two supports could be replaced with a damper, magnet pair, or other mechanism. In some embodiments the elastic element may be removed entirely, for instance, if it is replaced by a mechanism that uses gravity to provide an upward restoring force on the outer support, which thereby functions to constrain downward sliding of the outer support relative the inner support. Such a mechanism could consist of a cable from the outer support that goes around a pulley and connects to a counterweight, or could be accomplished with other mechanical mechanisms. Alternatively, the elastic element can be simply removed without a replacement such that the inner and outer supports slide with respect to each other without restoring back automatically, though that may partially affect the comfort benefits associated with the loosening effect afforded by the inclusion of an elastic element.

The term assistive device is used broadly, and also may include rehabilitative or resistive devices that are intended to assist, augment, support and/or train users through mechanical interaction forces exerted by the device.

The self-balancing harness 100 of the present disclosure could be used as a component of an assistive, rehabilitative or wearable device, such as an exoskeleton, exosuit, prosthesis or orthosis. It could be used in powered, quasi-passive, or passive assistive devices. One important practical application is that this invention allows an exosuit to be integrated into or onto equipment or gear (such as an IOTV). Either the equipment or gear (e.g., the IOTV) is considered a body interface in this disclosure. The invention prevents shifting of the underlying equipment or gear, which would otherwise cause discomfort and undermine assistive function.

The method steps in any of the embodiments described herein are not restricted to being performed in any particular order. Also, structures or systems mentioned in any of the method embodiments may utilize structures or systems mentioned in any of the device/system embodiments. Such structures or systems may be described in detail with respect to the device/system embodiments only but are applicable to any of the method embodiments.

For purposes of this disclosure, the phrase “clutch mechanism” or “clutch” may include any device that engages and disengages mechanical elements (e.g., elastic members or portions thereof) that bear or transmit force or mechanical power. A clutch mechanism may be unpowered such that it engages and disengages based on manual input (e.g., via a manual actuator such as a switch or toggle) or movement from the user, and may include one or more springs that bias the clutch towards a nominal mode (e.g., on or off). Alternatively, a clutch mechanism may be powered such that a motor or other actuator with its own power supply is used to control engagement and disengagement. Additionally, a motor or other actuator may be used to control the position of clutch engagement relative to one or more mechanical elements (e.g., elastic members), or to control the set point of an elastic member relative to the position of clutch engagement, thereby adjusting or setting the tension of, for example, elastic member(s). The clutch mechanism may be used in combination with additional motors or other actuators that provide tensile force or perform work along (parallel with) the elastic members, or provide force transverse or perpendicular to the elastic members. The engaging and disengaging by the clutch mechanism of a mechanical element may be achieved by any form of clutch or brake or mechanism providing a similar function, for example, a ratchet, dog clutch, cam clutch, friction clutch, overrunning clutch, disc brake, drum brake, latch, buckle, variable-ratio gear, or other resecurable fastening device.

Features in any of the embodiments described in this disclosure may be employed in combination with features in other embodiments described herein, such combinations are considered to be within the spirit and scope of the present invention.

The contemplated modifications and variations specifically mentioned in this disclosure are considered to be within the spirit and scope of the present invention.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

For purposes of this disclosure, the terms “channel”, “track”, “groove”, “slot”, “rail”, “slit”, “aperture”, “hole”, “opening”, and “notch” may all be used interchangeably. For purposes of this disclosure, the phrase “leaning” is interchangeable with the terms “hinging”, “flexing”, “extending”, “bending”, “stooping”, and/or any combination of those movements or postures. For purposes of this disclosure, the phrase “strap” is interchangeable with the terms “string”, “cable”, “cord/cording”, “webbing”, “rope”, “band”, and/or any combination thereof.

It is noted that the description and claims may use geometric or relational terms, used in the specification, such as front, back, right, left, above, below, upper, lower, top, bottom, linear, arcuate, elongated, parallel, perpendicular, etc. Those terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

What is claimed is:

1. A harness for a wearable assistance device comprising:
an inner support configured to be attached to a first side of a body interface;
a movable outer support slidably coupled to the inner support and configured to connect to a wearable assistance device; and
a strap attachment connected to the movable outer support and configured to be attached to a second side of the body interface that is opposite the first side of the body interface,
wherein the movable outer support moves axially relative to the inner support from an unloaded position to a loaded position upon application of a load from the wearable assistance device.

2. The harness of claim 1, wherein a movable connecting mechanism is positioned at the inner support, at the outer support, or between the inner support and outer support, the movable connecting mechanism being configured to allow the outer support to be slidably coupled to the inner support.

3. The harness of claim 2, wherein the movable connecting mechanism comprises at least one fastener receivable in at least one corresponding slot.

4. The harness of claim 3, wherein a length of the at least one corresponding slot defines the maximum displacement of the outer support with respect to the inner support.

5. The harness of claim 1, wherein one or more elastic elements couple the outer support to the inner support, and wherein the elastic element is configured to deform when the outer support moves relative to the inner support.

6. The harness of claim 1, wherein the one or more elastic elements are elastic bands.

7. The harness of claim 1, wherein a top portion of the inner support is configured to connect to the first side of a body interface, and a bottom portion of the outer support is configured to connect to the second side of the body interface via the strap attachment.

8. The harness of claim 7, wherein the first side of the body interface is at a user's posterior trunk, and the second side of the body interface is at a user's anterior trunk.

9. The harness of claim 1, wherein the strap attachment includes at least one strap connected at one end to the outer support and at an opposite end to the second side of the body interface.

10. The harness of claim 1, wherein each of the inner and outer supports is a plate.

11. The harness of claim 1, wherein the outer support is connected to at least one element of the wearable assistance device that provides assistive force.

12. A wearable assistance device comprising the harness of claim 1.

13. A harness for a wearable assistance device comprising:
an inner plate configured to be attached to a first side of a body interface wearable by a user;
a movable outer plate slidably coupled to the inner plate and configured to connect to at least one element of a wearable assistance device that provides assistive force; and
a strap attachment connected to the movable outer plate and configured to be attached to a second side of the body interface that is opposite the first side of the body interface,
wherein the movable outer plate moves axially relative to the inner plate from an unloaded position to a loaded position upon application of a load from the wearable assistance device to balance against the assistive force.

14. The harness of claim 13, wherein the strap attachment includes at least one strap connected at one end to the outer plate and at an opposite end to the second side of the body interface.

15. The harness of claim 14, wherein a bottom portion of the outer plate is connected to the one end of the at least one strap of the strap attachment.

16. The harness of claim 15, wherein the at least one strap runs under the arm of the user.

17. The harness of claim 13, wherein a movable connecting mechanism is positioned at the inner plate, at the outer plate, or between the inner plate and outer plate, the movable connecting mechanism being configured to allow the outer plate to be slidably coupled to the inner plate and defines the maximum displace out the outer plate with respect to the inner plate.

18. The harness of claim 17, wherein the movable connecting mechanism comprises at least one fastener receivable in at least one slot.

19. The harness of claim 13, wherein one or more elastic elements couple the outer and inner plates, and wherein the elastic element is configured to deform when the outer plate moves relative to the inner plate.

20. The harness of claim 13, wherein the body interface is a body armor vest.

21. A wearable assistance device comprising the harness of claim 13.
